(19) United States
(12) Patent Application Publication
(10) Pub. No.: US 2021/0042980 A1
(43) Pub. Date: Feb. 11, 2021

(54) METHOD AND ELECTRONIC DEVICE FOR DISPLAYING ANIMATION

(71) Applicant: Beijing Dajia Internet Information Technology Co., Ltd., Beijing (CN)

(72) Inventors: Lei Tian, Beijing (CN); Paliwan Pahaerding, Beijing (CN); Yanqing Wang, Beijing (CN); Xiaoyan Guo, Beijing (CN); Yuan Zhang, Beijing (CN)

(21) Appl. No.: 17/079,102

(22) Filed: Oct. 23, 2020

(30) Foreign Application Priority Data
Oct. 24, 2019 (CN) 201911017551.8

(51) Int. Cl. G06T 13/20; G06T 19/20

(52) U.S. Cl. CPC G06T 13/20; G06T 2219/2024; G06T 2200/24; G06T 19/20

(57) ABSTRACT

The disclosure relates to a method and an electronic device for displaying animation. The method includes: a display instruction is received, wherein the display instruction is configured to trigger the electronic device to display an animation corresponding to an animation model; a spatial parameter of an image device is obtained, wherein the spatial parameter indicates coordinates in a spatial model; an initial position of the animation model in the spatial model is determined based on the special parameter; and the animation at the initial position is displayed based on a skeleton animation, wherein the skeleton animation is generated based on the animation model.

### CROSS-REFERENCE TO RELATED APPLICATION

This disclosure is based on and claims priority under 35 U.S.C 119 to Chinese Patent Application No. 201911017551.8, filed on Oct. 24, 2019, in the China National Intellectual Property Administration, the disclosures of which are herein incorporated by reference in its entirety.

### FIELD

The disclosure relates to the technical field of computer vision, and particularly, to a method and an electronic device for displaying animation.

### BACKGROUND

As the application of a smart mobile device becomes wider and wider, a shooting function of the smart mobile device also becomes more and more powerful. Augmented Reality (AR) is a technology of calculating a position and an angle of an image shot by a camera in real time and adding a corresponding image, video and animation model. The AR can fuse the virtual world with the real world in a screen, for example, a virtual object model is overlaid into a current video content scene.

However, when the user views the video, it is difficult for the user to feel the motion of the virtual object model in a three-dimensional space, resulting in that user experience needs to be improved.

### SUMMARY

The disclosure provides a method and an electronic device for displaying animation.

According to the first aspect of the embodiments of the disclosure, provided is a method for displaying animation, applied to an electronic device, including:

receiving a display instruction, wherein the display instruction is configured to trigger the electronic device to display an animation corresponding to an animation model;

obtaining a spatial parameter of an image device, wherein the spatial parameter indicates coordinates in a spatial model;

determining an initial position of the animation model in the spatial model based on the special parameter; and

displaying the animation at the initial position based on a skeleton animation, wherein the skeleton animation is generated based on the animation model.

According to the second aspect of the embodiments of the disclosure, provided is an electronic device, including:

a processor; and

a memory for storing an instruction capable of being executed by the processor,
wherein the processor is configured to execute the instruction to perform the method for displaying animation provided by the first aspect of the embodiments of the disclosure.

According to the third aspect of the embodiments of the disclosure, provided is a non-transitory computer-readable storage medium, configured to store instructions which are executed by a processor of an electronic device to enable the electronic device to perform the method for displaying animation provided by the first aspect of the embodiments of the disclosure.

### BRIEF DESCRIPTION OF THE DRAWINGS

The accompanying drawings herein are incorporated into the specification, constitute one part of this specification, show the embodiments according to the disclosure, are used for explaining the principle of the disclosure together with the specification, and do not constitute an improper limitation to the disclosure.

FIG. 1 is a flow chart of a method for displaying animation according to the embodiments of the disclosure.

FIG. 2 is a schematic diagram of establishment of a spatial model coordinate system according to the embodiments of the disclosure.

FIG. 3 is a flow chart of a second method for displaying animation according to the embodiments of the disclosure.

FIG. 4 is a flow chart of a third method for displaying animation according to the embodiments of the disclosure.

FIG. 5 is a block diagram of an electronic device (a general structure of a mobile terminal) according to the embodiments of the disclosure.

FIG. 6 is a block diagram of an electronic device (a general structure of a server) according to the embodiments of the disclosure.

### DETAILED DESCRIPTION OF THE EMBODIMENTS

In order to make those ordinary skilled in the art understand the technical solutions of the disclosure better, the technical solutions in the embodiments of the disclosure will be described in a clearly and fully understandable way in combination with the drawings.

It should be noted that words such as “first”, “second” and the like in the specification and claims of the disclosure and the drawings are used for distinguishing similar objects, but not necessarily used for describing a specific sequence or order. It should be understood that data used in this way can be interchanged in proper cases, so that the embodiments of the disclosure, as described herein, can be implemented in a sequence except for those illustrated or described herein. Implementations described in the following exemplary embodiments do not represent all the implementations consistent with the disclosure. On the contrary, they are merely examples of an electronic device and a method consistent with some aspects of the disclosure, as described in detail in the appended claims.

Methods of the disclosure may be performed by an electronic device. The electronic device may a mobile phone, a computer, a digital broadcasting terminal, a message transceiving device, a game console, a tablet device, a medical device, a fitness device, a personal digital assistant and the like.

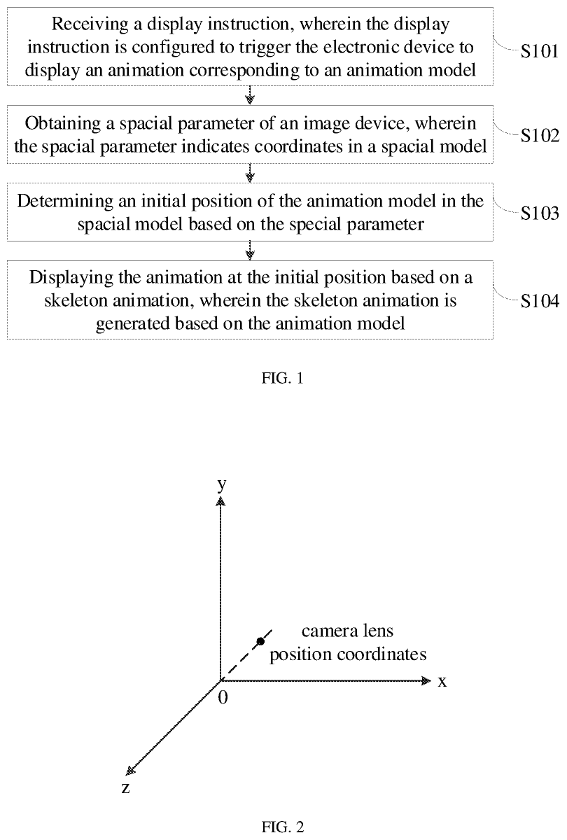

FIG. 1 is a flow chart of a method for displaying animation according to embodiments of the disclosure, and as shown in FIG. 1, the method for displaying animation is applied to the electronic device, and includes the following steps.

S101, a display instruction is received, wherein the display instruction is configured to trigger the electronic device to display an animation corresponding to an animation model.

In the embodiments of the disclosure, the animation model to be displayed may be a model of a virtual object, e.g., a playing card model, the playing card model can simulate a process of falling from a certain position in a space, and the process forms an animation. Upon the display instruction is received, at the moment, an electronic device just receives the display instruction, but does not display the animation model, and thus, the animation model is referred to as the animation model to be displayed. Certainly, the animation model to be displayed in the embodiments of the disclosure is not limited to the example illustrated above.

The electronic device can receive the display instruction for the animation model to be displayed, and the display instruction is used for triggering the electronic device to display an animation of the animation model to be displayed, and for example, triggering display in a screen of the electronic device of the process that the playing card falls from a height.

Exemplarily, a user can send the display instruction to the electronic device in the process of viewing or shooting a short video, and then the electronic device can receive the display instruction and display the animation of the animation model to be displayed on an image of the short video viewed or shot by the user, then the user feels an immersive AR effect.

In some embodiments of the disclosure, the electronic device can receive a one-click operation, a long-press operation or a continuous click operation of the user at a preset position of the screen of the electronic device so as to generate the display instruction, and the preset position may be a certain reset region of the screen, or a virtual button in an application.

S102, a spatial parameter of an image device is obtained, wherein the spatial parameter indicates coordinates in a spatial model.

It should be understood that the electronic device (e.g., a mobile terminal) used by the user generally is provided with the imaging device, e.g., a camera of a smart phone, and thus, the electronic device can acquire the spatial parameter of the imaging device, e.g., a position parameter of the camera in a camera coordinate system and a rotation parameter of the camera in the camera coordinate system. It is thus clear that the spatial parameter can be used for representing a coordinate azimuth of the imaging device in a spatial model, the spatial model may be preset and established by utilizing a preset 3D engine, and certainly, the spatial parameter may also be acquired in combination with a sensor of the electronic device, e.g., a gyroscope and the like.

S103, an initial position of the animation model in the spatial model is determined based on the special parameter.

The animation model is displayed in a virtual space, and thus, before the animation model to be displayed is displayed, the initial position of the animation model to be displayed in the virtual space can be determined first, and according to the embodiments of the disclosure, the initial position of the animation model to be displayed in the spatial model can be determined by utilizing the spatial parameter of the imaging device. The spatial parameter can represent the coordinate azimuth of the imaging device in the spatial model, and thus, a high-and-low distance, a left-and-right distance and a far-and-near distance of the animation model to be displayed in the spatial model can be determined by utilizing the spatial parameter, rather than just the high-and-low distance and the left-and-right distance of the animation model to be displayed are determined, so that an original two-dimensional motion mode simulated by the animation model to be displayed is changed into a three-dimensional motion mode.

S104, the animation at the initial position is displayed based on a skeleton animation, wherein the skeleton animation is generated based on the animation model. The coordinates of the initial position is determined by adding the position coordinates of the image device with a first displacement; wherein the first displacement is calculated based on a preset distance scalar and a first direction, and the first direction is same as the direction of the image device in the spatial model.

After the initial position of the animation model to be displayed in the spatial model is determined, the animation of the animation model to be displayed can be displayed at the initial position in the spatial model, and for example, the animation that the playing card falls is displayed. In order to simulate different display effects, different skeleton animations can be pre-generated for the animation model to be displayed, the skeleton animation is a common model animation mode, the model has a skeleton structure consisting of “skeletons” connected mutually in the skeleton animation, and the animation is generated for the model by changing orientations and positions of the skeletons, and thus, the skeleton animation has higher flexibility. Exemplarily, different skeleton animations can be produced for the playing card model so as to simulate an effect that the playing card randomly falls down.

In some embodiments of the disclosure, the animation of the animation model to be displayed may be displayed on a video image currently played, for example, displayed on a video image currently played and the video image was recorded by an anchor.

In some embodiments of the disclosure, the S102 specifically may be that: position coordinates and a direction of the imaging device in the spatial model are acquired.

The S103 specifically may be that: the position coordinates of the imaging device are added with a preset displacement to obtain coordinates of the initial position.

With reference to FIG. 2, a coordinate system can be established for the spatial model and represented with three axes of x, y and z, and exemplarily, position coordinates (0, 0, −1) of the camera are acquired, and it can be known that the position coordinates are positioned on a negative direction axis of the z axis; and the position coordinates of the imaging device are added with the preset displacement so as to obtain coordinates which are initial position coordinates of the animation model to be displayed. Wherein the preset displacement can be obtained by multiplying a preset distance scalar of the camera with a first direction. The preset distance scalar can be set according to a required far-and-near distance of the model to be displayed. In this example, the greater the distance scalar is, the farther the model to be displayed seems in the spatial model. It is thus clear that the distance scalar can be used for controlling the far-and-near distance (a movement distance on the z axis) of the model to be displayed; and the first direction may be the same with the direction of the imaging device in the spatial model, e.g., a negative direction of the z axis in the spatial model.

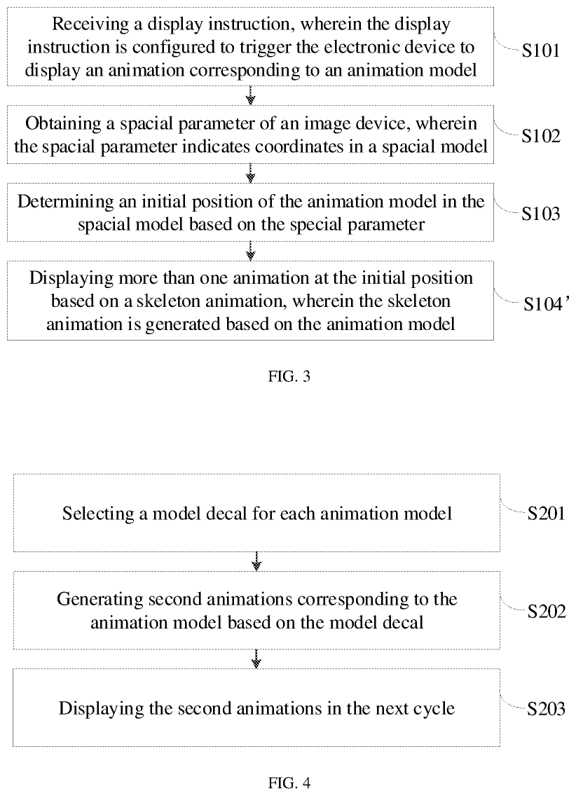

In some embodiments of the disclosure, as shown in FIG. 3, the S104 specifically may be that: S104′, more than one animation at the initial position based on a skeleton animation, wherein the skeleton animation is generated based on the animation model.

If it is expected to display animations of a plurality of models and achieve an effect that the plurality of models have synchronous animation effects, the plurality of models can share one parent space and be shifted together in the same direction in the parent space. The parent space may be preset in the spatial model, and for example, an origin of the parent space is set at the initial position in the spatial model. Specifically, each model of the plurality of models can generate the same offset in a second preset direction relative to the origin of the parent space, and for example, each playing card model is shifted down in a y-axis direction so as to generate an animation that a plurality of playing cards fall together from top to bottom in the spatial model. Certainly, the embodiments of the disclosure do not make any limit to the specific movement direction of the model.

In some embodiments of the disclosure, when it is expected to display animations of a plurality of models, the displaying the animations of the plurality of animation models at the initial position in the spatial model specifically may be that: an origin of a parent space is determined; and multiple animations at positions with a same offset in a second direction relative to the origin of the parent space is displayed. The animations is displayed circularly at a time interval.

When it needs to display animations of a plurality of models, the animations of the plurality of animation models to be displayed can be displayed cyclically in sequence at the preset time interval. Exemplarily, a magic expression option can be set in the application used by the user; when the user selects a playing card falling animation in this option, i.e., when animations of a plurality of models to be displayed need to be displayed, firstly, a first playing card falls down, the electronic device starts timing, after an interval of 2 seconds, a second playing card falls down, after another interval of 2 seconds, a third playing card falls down, after yet another interval of 2 seconds, a fourth playing card falls down and so on; after display of the falling animation of the animation model of each playing card is finished, i.e., the playing card is displayed to fall to the bottom, the animation model is continuously subjected to cyclic display so as to form an animation that the playing card continues to fall down from the top; and the animations of the plurality of animation models to be displayed are displayed cyclically in this way so as to form an animation that the playing cards continuously fall down in the screen.

In some embodiments of the disclosure, as shown in FIG. 4, the method for displaying animation may further include the following steps.

S201, a model decal for each animation model is selected.

S202, second animations corresponding to the animation model is generated based on the model decal.

S203, the second animations are displayed in the next cycle.

In the process of displaying the animations of the plurality of animation models to be displayed circularly in sequence at the preset time interval, according to the embodiments of the disclosure, different model decals can be used to display circularly on the animations of the animation models to be displayed. Specifically, the required decal is acquired from a file path by utilizing a pre-established corresponding table between names and file paths of a plurality of decals, and the decal is applied to the animation of the model to be displayed. A selecting mode of the model decal may be that: the respective random numbers corresponding to the respective decals are generated according to a preset number of a plurality of model decals, and then one random number is selected, i.e., the decal corresponding to the random number is obtained. By applying different model decals to the animation of the animation model to be displayed cycled each time, the user can feel that the animation of the current display model is random.

In some embodiments of the disclosure, the method for displaying animation according to the embodiments of the disclosure may further include: an operation instruction from the user for a currently displayed animation of the animation model is received, and a state of a currently displayed animation of the animation model is switched into a displayed state or a paused state.

In some embodiments of the disclosure, the user may also pause or continue the display process of the model. For example, a screen click instruction from the user is received, each time when the instruction is received, the state of the currently displayed animation of the animation model is switched, e.g., from the paused state to a played state, or from the played state to the paused state, i.e., switched between the displayed state and the paused state.

In some embodiments of the disclosure, the method for displaying animation may further include: when the imaging device moves, the initial position where the animation model is displayed is fixed.

After the initial position of the animation model is determined, according to the embodiments of the disclosure, it can be that when the imaging device moves, the initial position where the animation of the animation model to be displayed is displayed is fixed, and thus, as the imaging device moves or rotates, the electronic device continuously acquires information of the imaging device and carries out calculation, so that the initial position of the animation model to be displayed is kept unchanged in the present spatial model.

The 3D engine in some embodiments of the disclosure may include: an animation module, a rendering module, a script executing module, an event processing module and the like, the plurality of modules cooperate to implement a magic expression, e.g., simulate the process that the playing card falls down, wherein the rendering module can carry out rendering on the module to be displayed and provide an interface for switching textures of materials, the animation module can play the animation of the module to be displayed and supports switching between the played and paused states, the script executing module can control the falling process of the playing card logically, and the event processing module can receive the display instruction of the user and trigger a model animation display action.

According to the method for displaying animation provided by the embodiments of the disclosure, after the display instruction for the animation of the animation module to be displayed is received, by acquiring the spatial parameter of the imaging device used by the user, the initial position of the animation module to be displayed in the spatial model is determined based on the spatial parameter of the imaging device, and then the animation of the animation module to be displayed is displayed at the initial position in the spatial model by utilizing the pre-generated skeleton animation of the animation module to be displayed, so that the animation of the animation module to be displayed can be displayed in the space, then the user feels a motion situation of a virtual object model in a three-dimensional space when viewing.

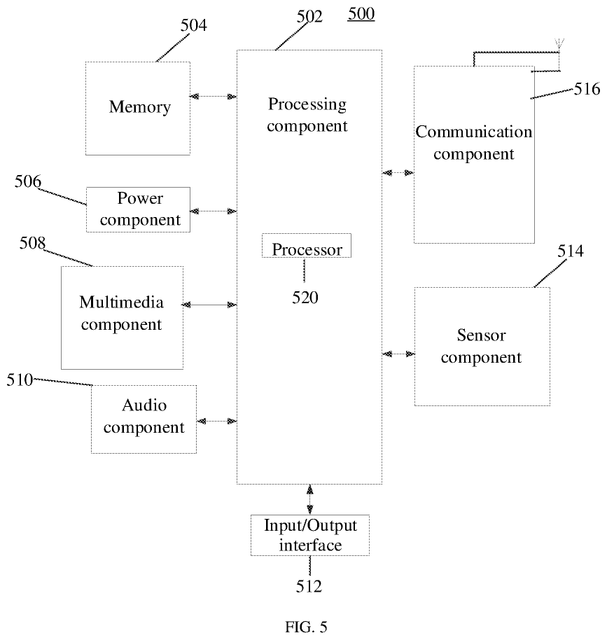

FIG. 5 is a block diagram of an electronic device 500 for animation display according to some embodiments. For example, the electronic device 500 may be a mobile phone, a computer, a digital broadcasting terminal, a message transceiving device, a game console, a tablet device, a medical device, a fitness device, a personal digital assistant and the like.

With reference to FIG. 5, the electronic device 500 may include one or more of the following components: a processing component 502, a memory 504, a power component 506, a multimedia component 508, an audio component 510, an Input/Output (I/O) interface 512, a sensor component 514, and a communication component 516.

The processing component 502 generally controls the overall operation of the electronic device 500, e.g., the operation associated with display, telephone calling, data communication, the camera operation and the recording operation. The processing component 502 may include one or a plurality of processors 520 for executing the instruction so as to complete all or part of the steps in the method. In addition, the processing component 502 may include one or a plurality of modules so as to facilitate interaction between the processing component 502 and other components. For example, the processing component 502 may include a multimedia module so as to facilitate interaction between the multimedia component 508 and the processing component 502.

The memory 504 is configured to store various types of data so as to support operations on the device 500. Examples of the data include instructions of any application or method, which are used for being operated on the electronic device 500, contact data, telephone directory data, messages, pictures, videos and the like. The memory 504 may be implemented by any type of volatile or nonvolatile memory devices or a combination thereof, e.g., a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or a compact disc.

The power component 506 provides power to various components of the electronic device 500. The power component 506 may include a power management system, one or more power supplies and other components associated with generation, management and distribution of power for the electronic device 500.

The multimedia component 508 includes a screen for providing an output interface between the electronic device 500 and the user. In some embodiments, the screen may include a Liquid Crystal Display (LCD) and a Touch Panel (TP). If the screen includes the touch panel, the screen can be implemented as a touch screen so as to receive an input signal from the user. The touch panel includes one or a plurality of touch sensors for sensing a touch, sliding and a gesture on the touch panel. The touch sensor can not only sense a boundary of a touch or sliding action, but also detect duration and a pressure related to the touch or sliding operation. In some embodiments, the multimedia component 508 includes a front camera and/or a rear camera. When the device 500 is in an operation mode, e.g., a shooting mode or a video mode, the front camera and/or the rear camera can receive external multimedia data. Each front camera and rear camera may be a fixed optical lens system or have focal length and optical zooming capacity.

The audio component 510 is configured to output and/or input an audio signal. For example, the audio component 510 includes a microphone (MIC), and when the electronic device 500 is in an operating mode, e.g., a calling mode, a recording mode and a voice identifying mode, the microphone is configured to receive an external audio signal. The received audio signal can be further stored in the memory 504 or sent via the communication component 516. In some embodiments, the audio component 510 further includes a loudspeaker for outputting the audio signal.

The I/O interface 512 provides an interface between the processing component 502 and a peripheral interface module, and the peripheral interface module may be a keyboard, a click wheel, a button and the like. Those buttons may include, but be not limited to: a homepage button, a volume button, a start button and a lock button.

The sensor component 514 includes one or a plurality of sensors for providing state evaluation in each aspect for the electronic device 500. For example, the sensor component 514 can detect an on/off state of the device 500 and relative positioning of components, for example, the components are a display and a keypad of the electronic device 500, and the sensor component 514 can also detect a position change of the electronic device 500 or one component of the electronic device 500, existence or nonexistence of contact between the user and the electronic device 500, an azimuth or acceleration/deceleration of the electronic device 500 and a temperature change of the electronic device 500. The sensor component 514 may include a proximity sensor which is configured to detect existence of an object nearby when there is no any physical contact. The sensor component 514 may also include an optical sensor, e.g., a Complementary Metal Oxide Semiconductor (CMOS) or Charge Coupled Device (CCD) image sensor, for use in the imaging application. In some embodiments, the sensor component 514 may further include an acceleration sensor, a gyroscope sensor, a magnetic sensor, a pressure sensor or a temperature sensor.

The communication component 516 is configured to facilitate communication in a wired or wireless mode between the electronic device 500 and other devices. The electronic device 500 can access a wireless network based on the communication standard, e.g., WiFi, an operator network (such as 2G, 3G, 4G or 5G), or a combination thereof. In some embodiments of the disclosure, the communication component 516 receives a broadcast signal or broadcast related information from an external broadcast management system via a broadcast channel. In some embodiments of the disclosure, the communication component 516 further includes a Near Field Communication (NFC) module for promoting short range communication. For example, the NFC module can be implemented based on a Radio Frequency Identification (RFID) technology, an Infrared Data Association (IrDA) technology, an Ultra Wide Band (UWB) technology, a Bluetooth (BT) technology and other technologies.

In some embodiments of the disclosure, the electronic device 500 can be implemented by one or a plurality of Application Specific Integrated Circuits (ASICs), Digital Signal Processors (DSPs), Digital Signal Processing Devices (DSPDs), Programmable Logic Devices (PLD), Field Programmable Gate Arrays (FPGAs), controllers, microcontrollers, microprocessors or other electronic components, and used for executing the method for displaying animation.

In some embodiments of the disclosure, further provided is a non-temporary computer readable memory medium including an instruction, e.g., the memory 504 including the instruction, and the instruction can be executed by the processor 520 of the electronic device 500 so as to complete the method. For example, the non-temporary computer readable memory medium may be a ROM, a Random Access Memory (RAM), a CD-ROM (Compact Disc Read-Only Memory), a magnetic tape, a soft disk, an optical data storage device and the like.

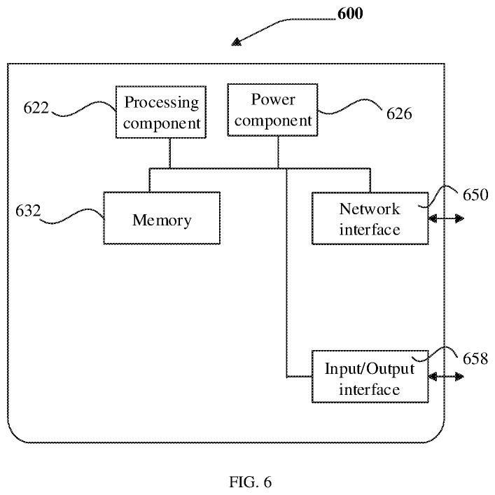

FIG. 6 is a block diagram of an electronic device 600 for animation display according to some embodiments of the disclosure. With reference to FIG. 6, the electronic device 600 includes a processing component 622 further including one or a plurality of processors, and a memory resource represented by a memory 632 and used for storing an instruction capable of being executed by the processing component 622, e.g., an application. The application stored in the memory 632 may include one or more than one module each of which corresponds to one group of instructions. In addition, the processing component 622 is configured to execute the instruction so as to execute the method for displaying animation.

The electronic device 600 may further include a power component 626 configured to execute power management of the electronic device 600, a wired or wireless network interface 650 configured to connect the electronic device 600 to a network, and an I/O interface 658. The electronic device 600 can operate an operation system stored in the memory 632, e.g., Windows Server™, Mac OS X™, Unix™, Linux™, FreeBSD™ or the like.

Those skilled in the art will easily think of other embodiments of the disclosure after considering the specification and practicing the disclosure disclosed herein. The disclosure aims to cover any modifications, applications or adaptive changes of the disclosure, and those modifications, applications or adaptive changes shall fall within the general principle of the disclosure and include common general knowledge or conventional technological means in the art, undisclosed by the disclosure. The specification and the embodiments are merely exemplary, and the real scope and spirit of the disclosure are only indicated by the appended claims.

It should be understood that the disclosure is not limited to the accurate structures which have been described above and shown in the drawings, and various modifications and changes can be made without departure from the scope of the disclosure. The scope of the disclosure is only limited by the appended claims.

What is claimed is:

1. A method for displaying animation, applied to an electronic device, comprising:
receiving a display instruction, wherein the display instruction is configured to trigger the electronic device to display an animation corresponding to an animation model;
obtaining a spatial parameter of an image device, wherein the spatial parameter indicates coordinates in a spatial model;
determining an initial position of the animation model in the spatial model based on the spatial parameter; and
displaying the animation at the initial position based on a skeleton animation, wherein the skeleton animation is generated based on the animation model.

2. The method according to claim 1, wherein said receiving the display instruction for the animation model comprises:
receiving a one-click operation, a long-press operation or a continuous click operation of the user at a preset position of a screen of the electronic device; and
generating the display instruction based on the one-click operation, the long-press operation or the continuous click operation.

3. The method according to claim 1, wherein said spatial parameter comprises:
position coordinates and a direction of the image device in the spatial model.

4. The method according to claim 3, said determining the initial position comprises:
determining the coordinates of the initial position by adding the position coordinates of the image device with a first displacement; wherein the first displacement is calculated based on a preset distance scalar and a first direction, and the first direction is same as the direction of the image device in the spatial model.

5. The method according to claim 1, wherein said displaying the animation of the animation model at the initial position comprises:
determining an origin of a parent space; and
displaying multiple animations at positions with a same offset in a second direction relative to the origin of the parent space.

6. The method according to claim 5, further comprising:
displaying the animations circularly at a time interval.

7. The method according to claim 6, further comprising:
selecting a model decal for each animation model;
generating second animations corresponding to the animation model based on the model decal; and
displaying the second animations in the next cycle.

8. The method according to claim 1, further comprising:
receiving an operation instruction of the user; and
switching into a displayed state or a paused state.

9. The method according to claim 1, further comprising:
fixing the initial position when the image device moves.

10. An electronic device, comprising:
a processor; and
a memory for storing an instruction capable of being executed by the processor, wherein the processor is configured to execute the instruction to:
receive a display instruction, wherein the display instruction is configured to trigger the electronic device to display an animation corresponding to an animation model;
obtain a spatial parameter of an image device, wherein the spatial parameter indicates coordinates in a spatial model;
determine an initial position of the animation model in the spatial model based on the special parameter; and
display the animation at the initial position based on a skeleton animation, wherein the skeleton animation is generated based on the animation model.

11. The electronic device according to claim 10, wherein the processor is further configured to execute the instruction to:
receive a one-click operation, a long-press operation or a continuous click operation of the user at a preset position of a screen of the electronic device; and
generate the display instruction based on the one-click operation, the long-press operation or the continuous click operation.

12. The electronic device according to claim 10, wherein said spatial parameter comprises:
position coordinates and a direction of the image device in the spatial model.

13. The electronic device according to claim 12, wherein the processor is further configured to execute the instruction to:
determine the coordinates of the initial position by adding the position coordinates of the image device with a first displacement; wherein the first displacement is calculated based on a preset distance scalar and a first direction, and the first direction is same as the direction of the image device in the spatial model.

14. The electronic device according to claim 10, wherein the processor is further configured to execute the instruction to:
determine an origin of a parent space; and
display multiple animations at positions with a same offset in a second direction relative to the origin of the parent space.

15. The electronic device according to claim 14, wherein the processor is further configured to execute the instruction to:
display the animations circularly at a time interval.

16. The electronic device according to claim 15, wherein the processor is further configured to execute the instruction to:
select a model decal for each animation model;
generate second animations corresponding to the animation model based on the model decal; and
display the second animations in the next cycle.

17. The electronic device according to claim 10, wherein the processor is further configured to execute the instruction to:
receive an operation instruction of the user; and
switch into a displayed state or a paused state.

18. The electronic device according to claim 10, wherein the processor is further configured to execute the instruction to:
fix the initial position when the image device moves.

19. A non-transitory computer-readable storage medium, configured to store instructions which are executed by a processor of an electronic device to enable the electronic device to:
receive a display instruction, wherein the display instruction is configured to trigger the electronic device to display an animation corresponding to an animation model;
obtain a spatial parameter of an image device, wherein the spatial parameter indicates coordinates in a spatial model;
determine an initial position of the animation model in the spatial model based on the special parameter; and
display the animation at the initial position based on a skeleton animation, wherein the skeleton animation is generated based on the animation model.

20. The non-transitory computer-readable storage medium according to claim 19, wherein the non-transitory computer-readable storage medium is further configured to enable the electronic device to:
receive a one-click operation, a long-press operation or a continuous click operation of the user at a preset position of a screen of the electronic device; and
generate the display instruction based on the one-click operation, the long-press operation or the continuous click operation.
